(19) United States
(12) Patent Application Publication
(10) Pub. No.: US 2025/0379644 A1
(43) Pub. Date: Dec. 11, 2025

(54) SIGNAL RELAY STATION AND BROADCASTING SYSTEM FOR LARGE GATHERING

(71) Applicant: I-FENG SU, Hsinchu City (TW)

(72) Inventor: I-FENG SU, Hsinchu City (TW)

(73) Assignee: BRILLIANT SILICON LIMITED, Aberdeen (HK)

(21) Appl. No.: 19/228,250

(22) Filed: Jun. 4, 2025

Related U.S. Application Data
(60) Provisional application No. 63/658,654, filed on Jun. 11, 2024.

(30) Foreign Application Priority Data
Nov. 25, 2024 (TW) 113145391

(51) Int. Cl. H04B 7/155; H04B 1/713; H04W 72/30

(52) U.S. Cl. CPC H04B 7/15507; H04B 1/713; H04W 72/30

(57) ABSTRACT

Embodiments of the present disclosure provide a signal relay station for large gatherings, capable of synchronously broadcasting with other signal relay stations. The signal relay station includes a receiver and a transmitter. The receiver is configured to receive to-be-broadcast data and output a correcting time signal. The transmitter is configured to receive the to-be-broadcast data and the correcting time signal from the receiver, and has packet broadcast events that occur respectively aligned with the other signal relay stations at a plurality of times according to the correcting time signal so as to broadcast the to-be-broadcast data. The transmitter broadcasts the to-be-broadcast data by using different frequency hopping between the signal relay station and the other signal relay stations.

### CROSS-REFERENCE TO RELATED INVENTION

This patent application claims the benefit of U.S. Provisional Application No. 63/658,654 filed on Jun. 11, 2024 and claims priority from Taiwan Patent Application No. 113145391 filed on Nov. 25, 2024, which are hereby incorporated herein by reference in its entirety.

### FIELD OF INVENTION

The embodiments of the present disclosure relate to a device, a method, and a system for group processing.

### BACKGROUND

Currently, live performances, events, and parties are often held in various types of venues, for example, concerts and performances in stadiums, performance halls, outdoor plazas, large spaces, etc. During live performances, events or parties, items like glow sticks and wristbands are often distributed to enhance the entertainment effect and interaction. However, the preparation of these items is often complex and time-consuming, requiring significant human resources. Additionally, the entertainment effect is limited by the inherent capabilities of the items. If there were devices, methods, and systems for group processing that could be regionally targeted and easily implemented at live performances or events, it would greatly enhance the experience of live performances, events or parties.

### SUMMARY

The embodiments of the present disclosure provide a signal relay station for large gatherings, capable of synchronously broadcasting with other signal relay stations. The signal relay station includes a receiver and a transmitter. The receiver is configured to receive to-be-broadcast data and output a correcting time signal. The transmitter is configured to receive the to-be-broadcast data and the correcting time signal from the receiver, and has packet broadcast events that occur respectively aligned with the other signal relay stations at a plurality of times according to the correcting time signal so as to broadcast the to-be-broadcast data, wherein the transmitter broadcasts the to-be-broadcast data by using different frequency hopping between the signal relay station and the other signal relay station.

In some embodiments, the signal relay station is configured to broadcast by synchronous frequency division duplex and configured to receive signals from a main transmitting device. In some embodiments, the transmitter is configured to broadcast a plurality of packets of the to-be-broadcast data by using different frequency hopping sequences. In some embodiments, the transmitter is configured to broadcast a plurality of packets of the to-be-broadcast data by using the same frequency hopping sequence. In some embodiments, a frequency set used by the receiver to receive the to-be-broadcast data is different from a frequency set used to broadcast the to-be-broadcast data. In some embodiments, the receiver is configured to output the correcting time signal to the transmitter after establishing a connection with a main transmitting device, and the correcting time signal is a synchronization signal that allows the transmitter to start broadcasting the to-be-broadcast data at a designate time. In some embodiments, the signal relay station has a connection with the main transmitting device through the receiver and the transmitter during a first period to perform unicast so as to receive the to-be-broadcast data, and the transmitter broadcasts the to-be-broadcast data during a second period. In some embodiments, a start time and a length of the first period are allocated and regulated by the main transmitting device when establishing a connection with the receiver, and the main transmitting device retransmits the to-be-broadcast data multiple times during the first period. In some embodiments, a time at which the receiver starts to receive the to-be-broadcast data is aligned with a time at which other signal relay stations start to broadcast the to-be-broadcast data. In some embodiments, the transmitter changes broadcast frequency for each packet broadcast event.

The embodiments of the present disclosure provide a broadcasting system for large gatherings, which includes a plurality of signal relay stations as described above. The transmitters of the signal relay stations each is aligned to one of packet broadcast events occurring at a plurality of times to respectively broadcast the to-be-broadcast data. The transmitters broadcast the to-be-broadcast data by using different frequency hopping between the signal relay stations.

The embodiments of the present disclosure provides a broadcasting system for large gatherings using synchronous frequency division duplexing, which includes a main transmitting device and a plurality of signal relay stations, wherein the signal relay stations sequentially and respectively enter a reception period to receive signals from the main transmitting device; and wherein, while one of the signal relay stations is in the reception period, others of the signal relay stations are in broadcast periods and have different frequency hopping therebetween and synchronously broadcast the to-be-broadcast data.

In some embodiments, the reception periods and the broadcast periods of the signal relay stations have same time frame unit, the length of the reception period equals one unit of time frame, and the length of the broadcast period equals a plurality of units of time frame. In some embodiments, a start time of one of the reception periods is aligned with a start time of one of the broadcast periods. In some embodiments, the signal relay stations change their broadcast frequency every one unit of time frame. In some embodiments, a frequency set used for receiving signals from the main transmitting device is different from a frequency set used for broadcasting the to-be-broadcast data. In some embodiments, some of the signal relay stations each starts to synchronously broadcast the to-be-broadcast data according to a synchronization signal. In some embodiments, the signal relay station in the reception period has a connection with the main transmitting device to perform unicast so as to receive the signal containing the to-be-broadcast data. In some embodiments, a start time and a length of the reception period are allocated and regulated by the main transmitting device when establishing a connection with the signal relay stations, and the main transmitting device retransmits the to-be-broadcast data multiple times during the reception period. In some embodiments, each of the signal relay stations includes a receiver and a transmitter, the receiver is configured to receive signals from the main transmitting device and output a correcting time signal; and the transmitter is configured to receive the correcting time signal from the receiver and has packet broadcast events that occur respectively aligned with the other signal relay stations at a plurality of times according to the correcting time signal so as to broadcast the to-be-broadcast data.

### BRIEF DESCRIPTION OF DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a schematic diagram of a broadcasting system for large gatherings according to an embodiment.

FIG. 2 is a schematic diagram illustrating the operation of a signal relay station according to an embodiment.

FIG. 3 is a schematic diagram illustrating the operation of a plurality of signal relay stations according to an embodiment.

FIG. 4 is a schematic diagram illustrating the operation of a receiving device according to an embodiment.

FIG. 5 is a schematic diagram of a group processing system according to an embodiment.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

Various types of gatherings, such as live performances, events or parties are often held in various venues, including stadiums, arenas, sports fields, squares, streets, roads, performance halls, and event centers. Live performances, events or parties, etc. include concerts, music festivals, sporting events, athletic activities, and entertainment events, etc. The embodiments of the present disclosure relate to devices, methods, and systems for group processing in venues, which are regionally targeted and easily implemented at live performances or events, making them more exciting. They also feature a simplified structure, cost reduction, and ease of maintenance.

Items with visual, auditory, or tactile effects, such as glow sticks, wristbands, towels with specific colors or patterns, and clothing, can be provided to the audience, crowd, or participants at live performances, events, or gatherings to produce explicit behavior effects. Items with visual effects can include light-emitting elements, items with auditory effects can include speakers or sound-generating components, and items with tactile effects can include vibrators. These items can serve as receiving devices by including receivers, and through the use of the disclosed transmitting device and/or group processing system, the receiving devices can exhibit explicit behaviors such as visual, auditory, or tactile effects. For example, visual effects might involve a plurality of receiving devices collectively presenting a pattern, such as text or a graphic. Visual effects might involve a screen of the receiving device displaying a pattern. For example, auditory effects could include the receiving devices which sound. For example, tactile effects could involve the receiving devices that generate vibrations. Additionally, mobile communication devices can serve as items with visual, auditory, and/or tactile effects as mentioned above. For example, a mobile communication device might have an application which is installed to communicate with the transmitting device and/or group processing system of the present disclosure, thereby exhibiting explicit behavior such as visual, auditory, or tactile effects.

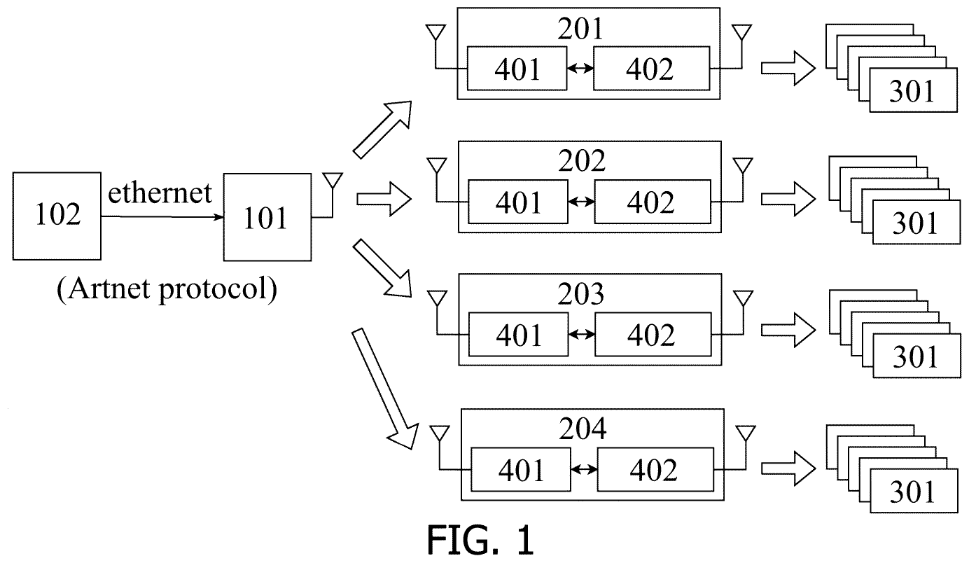

FIG. 1 is a schematic diagram of a broadcasting system for large gatherings according to an embodiment. The signal from the control station 102 is sent to the broadcasting system, and then broadcast by using the broadcasting system. In FIG. 1, the broadcasting system for large gatherings includes a plurality of signal relay stations (illustrated as 201-204, but not limited to this number). The signal relay stations 201-204 broadcast the signal from a main transmitting device 101 to a plurality of receiving devices 301. Communication between the main transmitting device 101, the signal relay stations 201-204, and the receiving devices 301 can be wireless. The main transmitting device 101 and the control station 102 can communicate via either wired or wireless means. The number of signal relay stations 201-204 can vary depending on the size of the venue or the complexity of the planning for live performances, events, or gatherings. For medium to large scale live performances, events or parties, the number of signal relay stations 201-204 deployed in the venue could be in the hundreds or thousands or even more. Through these signal relay stations 201-204, a large number of receiving devices 301 can be configured or controlled, but the signal relay stations 201-204 and the receiving devices 301 do not require pre-pairing settings. It is possible to perform setting or control on the receiving device 301 through the signal relay stations 201-204 when the receiving device 301 is used on-site.

The main transmitting device 101 sends information or signals issued by the control station 102 to the signal relay stations 201-204. The information or signals can include control signals, commands, and/or data. The signal relay stations 201-204 broadcast the signals sent from the main transmitting device 101 to send the information from the control station 102 to the plurality of the receiving devices 301. The receiving device 301 can be an item or a mobile communication device with visual, auditory, and/or tactile effects, which can receive and execute commands and/or control signals contained in the information or signals from the control station 102.

Regarding synchronization, the main transmitting device 101 can first establish connections with the receivers 401 of the signal relay stations 201-204. After the connections are established, the receiver 401 of the signal relay stations 201-204 will output a correcting time signal (synchronization signal) to the transmitter 402. Each time a certain signal relay station receives a packet that is sent from the main transmitting device 101, the transmitter 402 can receive the correcting time signal (synchronization signal) from the receiver 401.

Regarding data transmission, after the data from the control station 102 is sent to the main transmitting device 101, the main transmitting device 101 will send the data to all the receivers 401 of the signal relay stations 201-204 through the connections between it and the receivers 401 of the signal relay stations 201-204. Each receiver 401 will then transmit the data to the transmitter 402, and each transmitter 402 will send the data by broadcasting to all receiving devices 301 within reception range. The receiving device 301 can be within the broadcast range of one of the signal relay stations, or it can be within the range of two, three, four, or more of these signal relay stations.

The signal relay station includes a receiver 401 and a transmitter 402. The receiver 401 and the transmitter 402 can be dedicated receiver and transmitter that only receives and broadcasts signals of specific sources. For example, only the signals of the main transmitting device 101 are received and broadcast, and other signals from different sources are not processed. The receiver 401 receives the information or signals issued by the control station 102 through the main transmitting device 101, while the transmitter 402 is primarily responsible for broadcasting the information or signals from the main transmitting device 101. The signal relay station broadcasts, for example, by relaying or forwarding. The signal relay station (e.g., 201) can be configured to broadcast and receive the signals from the main transmitting device 101 using synchronous frequency division duplexing with other signal relay stations (e.g., 202-204).

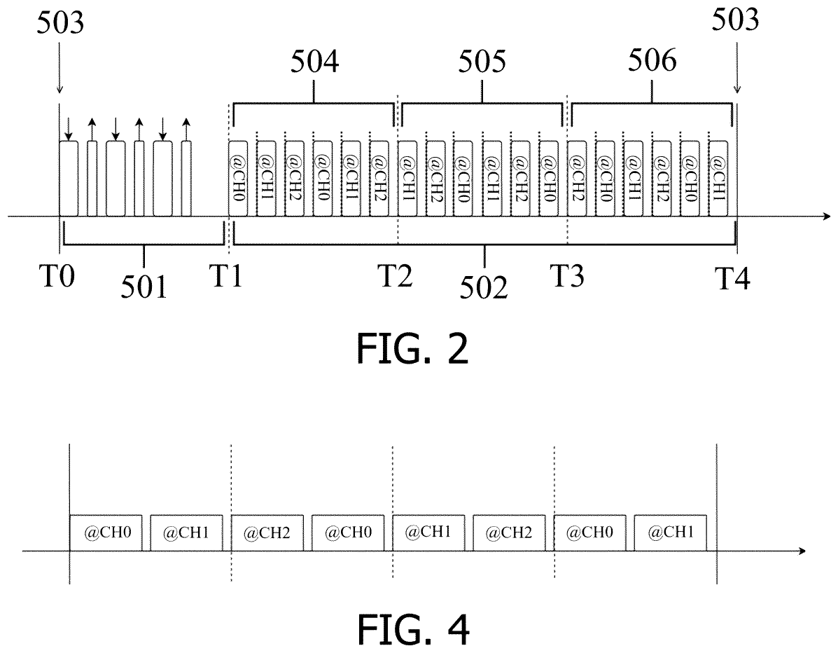

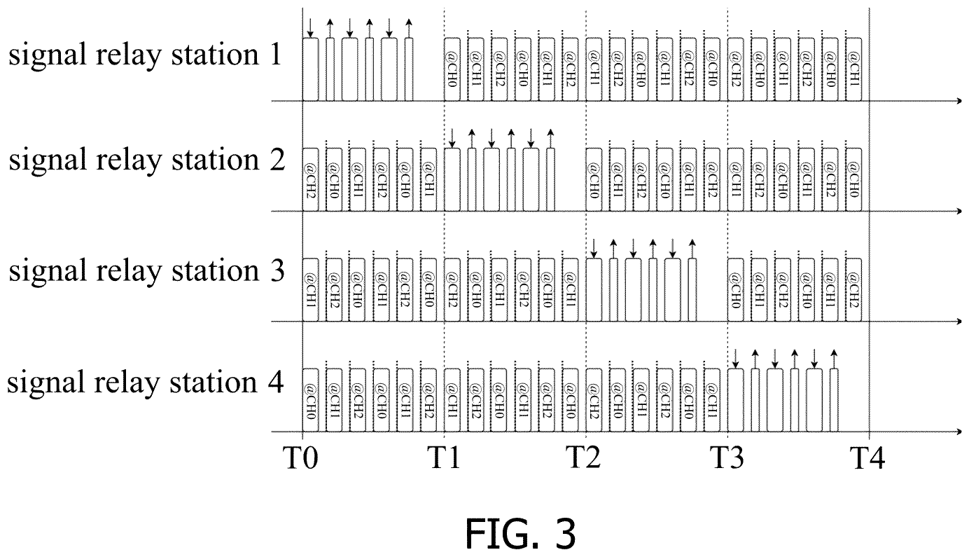

In some embodiments, after the main transmitting device 101 establishes a connection with the receiver 401, the receiver 401 outputs a correcting time signal to the transmitter 402. The correcting time signal is a synchronization signal that enables the transmitter 402 to start broadcasting the to-be-broadcast data at a designated time. The signal relay station has a connection with the main transmitting device 101 through the receiver 401 and the transmitter 402 during a first period (e.g., 501 in FIG. 3, or called as the reception period) to perform unicast so as to receive the to-be-broadcast data, and the transmitter 402 broadcasts the to-be-broadcast data during a second period (e.g., 502 in FIG. 3, or called as the broadcast period). A start time and a length of the first period are allocated and regulated by the main transmitting device 101 when establishing a connection with the receiver 401, and the main transmitting device 101 may retransmit the to-be-broadcast data multiple times during the first period to ensure that the data is correctly sent to the receiver 401. The reception periods and the broadcast periods of the signal relay stations may have same time frame unit, for example, the length of the reception period in FIG. 2 and FIG. 3 equals 1 unit of time frame, while the length of the broadcast period equals a plurality of units of time frame.

As shown in FIG. 2, a single transaction (503) performed by the signal relay station includes an action period 501 and an action period 502 following the action period 501. The action period 501 can be the connection period for communicating with the upper-level device (main transmitting device), and the communicating connection may be performed by unicast; the action period 502 can be the connection period for communicating with the lower-level devices (receiving devices), and the communicating connection may be performed by broadcast. The receiver 401 is configured to receive the to-be-broadcast data during the action period 501. During the action period 501, the signal relay station can have a connection to the main transmitting device 101 through receiver 401 and transmitter 402, and the connection manner may be unicast rather than broadcast. The main transmitting device 101 can send information of control station such as commands, etc. to the receiver 401 of the signal relay station by using unicast. For example, the downward arrows in FIG. 2 indicate that the receiver 401 receives signals from the main transmitting device 101, and the upward arrows indicate that the transmitter 402 transmits signals or replies to the main transmitting device 101, thereby enabling communication connection between the signal relay station and the main transmitting device 101. After the main transmitting device 101 establishes a connection with the receiver 401 at time TO, the receiver 401 outputs a correcting time signal to the transmitter 402, and the transmitter 402 broadcasts at times T1, T2, and T3 according to the correcting time signal. The signal relay station can determine the length of the act period 501 according to the allocation and regulation when the main transmitting device 101 establishes the connection with the receiver 401, and it will start the act period 501 again at time T4. The main transmitting device 101 can retransmit the to-be-broadcast data multiple times during the act period 501 to ensure that the data is correctly transmitted to the receiver 401.

The transmitter 402 is configured to have packet broadcast events that occur respectively aligned with the other signal relay stations at a plurality of times (as shown by the dashed lines at times T1, T2, and T3, or the solid line at time T0 in FIG. 3) according to the correcting time signal so as to broadcast the to-be-broadcast data during the act period 502. The transmitter 402 broadcasts the to-be-broadcast data during the act period 502 by using different frequency hopping between the signal relay station and the other signal relay station.

In some embodiments, the transmitter 402 is configured to broadcast a plurality of packets of the to-be-broadcast data by using different frequency hopping sequences. For example, in FIG. 2, different frequency hopping sequences include groups 504, 505, and 506. The frequency hopping sequence of group 504 is channels CH0, CH1, CH2, CH0, CH1, CH2, the frequency hopping sequence of group 505 is channels CH1, CH2, CH0, CH1, CH2, CH0, and the frequency hopping sequence of group 506 is channels CH2, CH0, CH1, CH2, CH0, CH1. The groups 504, 505, and 506 do not use the same channel at the same time due to the different frequency hopping sequences used by groups 504, 505, and 506. In some other embodiments, the transmitter 402 may be configured to broadcast a plurality of packets of the to-be-broadcast data by using the same frequency hopping sequence. For example, the frequency hopping sequences all are channels CH0, CH1, CH2, CH0, CH1, CH2. Additionally, a frequency set used for receiving to-be-broadcast data or signals from the main transmitting device is different from a frequency set used for broadcasting the to-be-broadcast data. The transmitter 402 may change broadcast frequency for each packet broadcast event, or may change broadcast frequency every 1 unit of time frame.

As shown in FIG. 3, the act period 501 of each signal relay station 1-4 occurs sequentially in time without overlapping, and each signal relay station is sequentially in a reception period to receive signals from the main transmitting device. For example, the upper-level device (main transmitting device) can establish communication connections with each signal relay station 1-4 by sequential scanning; the act period 502 of each signal relay station 1-4 also occurs sequentially in time. For example, from time T0 to time T1, it is the act period 501 of signal relay station 1 and the act period 502 of signal relay stations 2-4; from time T1 to time T2, it is the act period 501 of signal relay station 2 and the act period 502 of signal relay stations 1, 3-4; and so on. Most signal relay stations are in the act period 502, while a few are in the act period 501. While one of the signal relay stations is in the reception period, the others of the signal relay stations are in broadcast periods and have different frequency hopping therebetween and synchronously broadcast the to-be-broadcast data.

Since the receiver 401 of each signal relay station sends a correcting time signal to the transmitter 402, all transmitters 402 in the act period 502 will transmit the broadcast packets simultaneously. As shown in FIG. 3, the time at which the receiver 401 starts to receive the to-be-broadcast data is aligned with a time at which other signal relay stations start to broadcast the to-be-broadcast data. For example, at time T0, the receiver of the signal relay station 1 starts to receive the to-be-broadcast data, and the transmitters of the other signal relay stations 2-4 start to broadcast the to-be-broadcast data. This is also the case for times T1 to T3. Because the broadcast times of each signal relay station are aligned but the broadcast frequencies are different, the broadcast signals from each signal relay station do not interfere with each other.

Therefore, the transmitter 402 of the signal relay station can receive the correcting time signal from the receiver 401 to ensure that for each signal relay station during the act period 502, each packet broadcast event at each signal relay station occurs simultaneously. Additionally, by using different frequency hopping for each signal relay station, an effect of synchronous frequency division duplex (FDD) is achieved, allowing each signal relay station to transmit packets simultaneously but on different frequencies, thus avoiding interference between packets. While some numbers of the signal relay stations are in the act period 502 for broadcasting, still some numbers of the signal relay stations are in the action state 501 for receiving signals from the main transmitting device 101 (e.g., receiving to-be-broadcast data). The frequency sets used during periods 501 and 502 can be different, and the two sets do not include same frequency to avoid mutual interference.

As shown in FIG. 4, the receiving device 301 receives the information from the control station 102 broadcast by the transmitter 402 and listens to the broadcast packets by switching frequencies periodically.

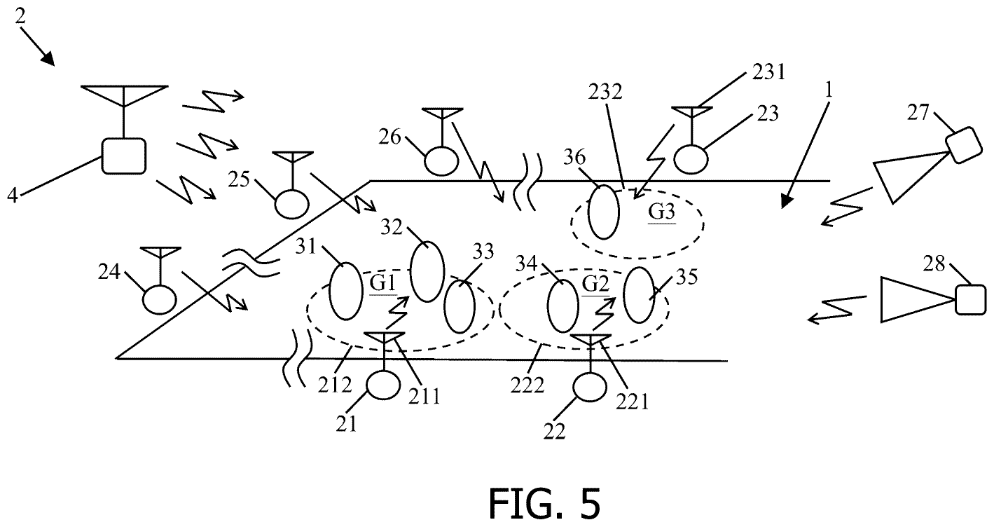

FIG. 5 is a schematic diagram of a group processing system according to an embodiment. The main transmitting device 101, the signal relay stations 201-204, and the receiving device 301 described in the aforementioned embodiment can be applied to the command transmitting device 4, transmitting devices 21-28, and receiving devices 31-36 in the group processing system shown in FIG. 5.

In FIG. 5, a group processing system 2 is used in a venue 1. The group processing system 2 includes a plurality of transmitting devices, such as transmitting devices 21-28. The number of transmitting devices depends on the size of the venue 1 or the complexity of the planning for live performance, event, or gathering. For medium to large-scale live performances, events, or gatherings, the number of transmitting devices deployed in the venue can be in the hundreds or thousands or even more. Through these transmitting devices, group control of a large number of receiving devices can be achieved, but group pairing settings of the transmitting devices and the receiving devices are not required. Group settings for the receiving devices can be performed via the transmitting devices as the receiving devices are used within the venue 1.

The transmitting device 21 includes a transmitter 211 and a command coverage area 212. The transmitter 211 is configured to transmit a group formation command, and the command coverage area 212 is an area within the venue 1 where the commands transmitted by transmitter 211 can be received. The transmitting device 22 includes a transmitter 221 and a command coverage area 222. Transmitter 221 is configured to transmit a group formation command, and the command coverage area 222 is an area within the venue 1 where the commands transmitted by transmitter 221 can be received. The transmitting device 23 includes a transmitter 231 and a command coverage area 232. The transmitter 231 is configured to transmit a group formation command, and the command coverage area 232 is an area within the venue 1 where the commands transmitted by transmitter 231 can be received. Other transmitting devices 24-28 also have transmitters and command coverage areas, their descriptions are not repeated here. Additionally, the transmitting device may include a receiver to receive commands from other devices.

The command coverage area decides the operation range of group members in the venue 1. The group formation command enables at least one receiving device within the command coverage area to form and/or be identified as a same group. The command coverage area enables a leaving receiving device no longer to belong to the same group within the command coverage area. For example, the transmitter 211 transmits a group formation command that enables the receiving devices 31-33 within the command coverage area 212 to form and/or be identified as the same group G1. The operation range of the members of group G1 (i.e., receiving devices 31-33) is decided by the command coverage area 212. Members of group G1 operate within the command coverage area 212 according to the instructions of group G1. If a member of group G1 moves outside the command coverage area 212, it no longer operates according to the instructions of group G1. Namely, members of group G1 only operate within the command coverage area 212 according to the instructions of group G1. The same or similarly, the above implementation also applies to other transmitting devices and the receiving devices within their command coverage areas. For example, the transmitter 221 transmits a group formation command that enables the receiving devices 34-35 within the command coverage area 222 to form and/or be identified as group G2. The transmitter 231 transmits a group formation command that enables the receiving device 36 within the command coverage area 232 to form and/or be identified as group G3. Members of group G2 only operate according to the instructions of group G2 within the command coverage area 222, and members of group G3 only operate according to the instructions of group G3 within the command coverage area 232.

For example, the receiving device 33 in FIG. 1 is within the command coverage area 212 belonging to group G1. Then, as shown in FIG. 2, the receiving device 33 leaves the command coverage area 212 and thus no longer belongs to group G1 and cannot receive commands from transmitter 211. The receiving device 33 moves into the command coverage area 222, and the group formation command transmitted from transmitter 221 enables the receiving devices 33 and 35 within the command coverage area 222 to form and/or be identified as group G2. In some embodiments, when the receiving device leaves or enters the command coverage area, a notification mechanism may be triggered. The notification mechanism could be, for example, a sound, light, vibration, message, or instruction, etc. The prompt target can be the holder, wearer, or user of the receiving device. For example, after the receiving device 33 leaves the command coverage area (e.g., 212) of one of the transmitting devices (e.g., 21), the receiving device 33 removes its group identification and generates a prompt to represent that it has left the command coverage area (e.g., 212); at the situation that the receiving device 33 enters the command coverage area (e.g., 222) of one of the transmitting devices (e.g., 22) in the venue and before receiving a group formation command from any of the transmitting devices (e.g., 22), the receiving device 33 receives any signal from these transmitting devices (e.g., 22) and generates a prompt to represent that it has entered the command coverage area (e.g., 222).

Besides, in some embodiments, only the receiving devices that are in the waiting mode for grouping setup will form and/or be identified as a same group according to the group formation command. The receiving devices not in the waiting mode for grouping setup will not start or re-initiate group formation and/or identification. For example, even if the receiving device not in the waiting mode for grouping setup receives the group formation command, it will retain its original group identification or has no group identification.

In some embodiments, each transmitter is configured to transmit a group action command that enables the receiving devices within the command coverage area of each transmitter to perform corresponding actions with respect to each group. This allows each receiving device to operate according to the instructions of its belonging group, thereby exhibiting explicit behaviors such as visual, auditory, and/or tactile effects. Additionally, the transmitting devices can also be grouped, for example, the transmitting devices 25 and 26 could belong to the same group, and transmitting devices 21-23 each belong to different groups. The command coverage areas of transmitting devices 25 and 26, which are in the same group, can overlap or not overlap. The receiving devices within the command coverage areas of transmitting devices 25 and 26 of the same group can form and/or be identified as a same group.

In some embodiments, the group formation command is a signal. At the situation that the group formation command is implemented as a signal, the transmitting device can be a wireless communication device, such as a relay station, and the transmitter of the transmitting device transmits the command by broadcast; the transmitter can be a wireless signal transmitter, which may include a transmitter circuit and an antenna component, etc.; the command coverage area is the coverage range of the wireless signal; the receiving device may include active or passive wireless communication components to receive the wireless signal.

In some embodiments, the system 2 further includes a command transmitting device 4, or one or more of the transmitting devices serve as command transmitting devices. The command transmitting device 4 is configured to define groups of the receiving devices and to transmit a group definition command to the transmitting devices 21-28, enabling each transmitter of the transmitting devices 21-28 to broadcast the group formation commands.

In some embodiments, the command transmitting device 4 is configured to transmit commands to single one, or a single group, or a plurality of groups of the transmitting devices 21-28. One of the transmitting devices 21-28 transmits commands to a single receiving device, or a single group, or a plurality of groups according to the command transmitting device 4. Thereby, this allows for the command transmission and control for a single transmitting device, or a single receiving device, or a single group of receiving devices, or a single group of transmitting devices, or a single group of receiving device and transmitting device, or multiple groups of receiving devices, or multiple groups of transmitting devices, or multiple groups of receiving devices and transmitting devices.

In some embodiments, the transmitting devices 21-28 are signal relay stations. The transmitters of the transmitting devices 21-28 transmit commands by broadcasting. The commands, for example, are group formation commands or group action commands. The relay stations, for example, may broadcast the commands received from the command transmitting device 4 by relaying or forwarding. The command transmitting device 4 can communicate with the transmitting devices 21-28 through wireless and/or wired means. In some embodiments, the command transmitting device 4 can communicate wirelessly with the transmitting devices 21-28, allowing for easy large-scale deployment, configuration, and modification, especially in applications requiring a large number of devices, such as live performances, events, or gatherings. In some embodiments, the command transmitting device 4 may also communicate wirelessly with the receiving devices, for example, using a broadcast method.

The foregoing outlines features of several embodiments or examples so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments or examples introduced herein. Those skilled in the art should also realize that such equivalent constructions do not depart from the spirit and scope of the present disclosure, and that they may make various changes, substitutions, and alterations herein without departing from the spirit and scope of the present disclosure.

1. A signal relay station for large gatherings, capable of synchronously broadcasting with other signal relay stations, comprising:
a receiver configured to receive to-be-broadcast data and output a correcting time signal; and
a transmitter configured to receive the to-be-broadcast data and the correcting time signal from the receiver, and has packet broadcast events that occur respectively aligned with the other signal relay stations at a plurality of times according to the correcting time signal so as to broadcast the to-be-broadcast data,
wherein the transmitter broadcasts the to-be-broadcast data by using different frequency hopping between the signal relay station and the other signal relay station.

2. The signal relay station of claim 1, wherein the signal relay station is configured to broadcast by synchronous frequency division duplex and configured to receive signals from a main transmitting device.

3. The signal relay station of claim 1, wherein the transmitter is configured to broadcast a plurality of packets of the to-be-broadcast data by using different frequency hopping sequences from another transmitter's sequence.

4. The signal relay station of claim 1, wherein the transmitter is configured to broadcast a plurality of packets of the to-be-broadcast data by using the same frequency hopping sequence, but with a different phase from another transmitter's phase.

5. The signal relay station of claim 1, wherein a frequency set used by the receiver to receive the to-be-broadcast data is different from a frequency set used to broadcast the to-be-broadcast data.

6. The signal relay station of claim 1, wherein the receiver is configured to output the correcting time signal to the transmitter after establishing a connection with a main transmitting device, and the correcting time signal is a synchronization signal that allows the transmitter to start broadcasting the to-be-broadcast data at a designate time.

7. The signal relay station of claim 6, wherein the signal relay station has a connection with the main transmitting device through the receiver and the transmitter during a first period to perform unicast so as to receive the to-be-broadcast data, and the transmitter broadcasts the to-be-broadcast data during a second period.

8. The signal relay station of claim 7, wherein a start time and a length of the first period are allocated and regulated by the main transmitting device when establishing a connection with the receiver, and the main transmitting device retransmits the to-be-broadcast data multiple times during the first period.

9. The signal relay station of claim 1, wherein a time at which the receiver starts to receive the to-be-broadcast data is aligned with a time at which other signal relay stations start to broadcast the to-be-broadcast data.

10. The signal relay station of claim 1, wherein the transmitter changes broadcast frequency for each packet broadcast event.

11. A broadcasting system for large gatherings, comprising:
a plurality of signal relay stations, each comprising:
a receiver configured to receive to-be-broadcast data and output a correcting time signal; and
a transmitter configured to receive the to-be-broadcast data and the correcting time signal from the receiver, and has packet broadcast events that occur respectively aligned with the other signal relay stations at a plurality of times according to the correcting time signal so as to broadcast the to-be-broadcast data,
wherein the transmitters of the signal relay stations each is aligned to one of the packet broadcast events occurring at the plurality of times to respectively broadcast the to-be-broadcast data,
wherein the transmitters broadcast the to-be-broadcast data by using different frequency hopping between the signal relay stations.

12. A broadcasting system for large gatherings using synchronous frequency division duplexing, comprising:
a main transmitting device;
a plurality of signal relay stations;
wherein the signal relay stations sequentially and respectively enter a reception period to receive signals from the main transmitting device; and
wherein, while one of the signal relay stations is in the reception period, others of the signal relay stations are in broadcast periods and have different frequency hopping therebetween and synchronously broadcast the to-be-broadcast data.

13. The broadcasting system according to claim 12, wherein the reception periods and the broadcast periods of the signal relay stations have same time frame unit, the length of the reception period equals one unit of time frame, and the length of the broadcast period equals a plurality of units of time frame.

14. The broadcasting system according to claim 12, wherein a start time of one of the reception periods is aligned with a start time of one of the broadcast periods.

15. The broadcasting system according to claim 12, wherein the signal relay stations change their broadcast frequency every one unit of time frame.

16. The broadcasting system according to claim 12, wherein a frequency set used for receiving signals from the main transmitting device is different from a frequency set used for broadcasting the to-be-broadcast data.

17. The broadcasting system according to claim 12, wherein some of the signal relay stations each starts to synchronously broadcast the to-be-broadcast data according to a synchronization signal.

18. The broadcasting system according to claim 12, wherein the signal relay station in the reception period has a connection with the main transmitting device to perform unicast so as to receive the signal containing the to-be-broadcast data.

19. The broadcasting system according to claim 12, wherein a start time and a length of the reception period are allocated and regulated by the main transmitting device when establishing a connection with the signal relay stations, and the main transmitting device retransmits the to-be-broadcast data multiple times during the reception period.

20. The broadcasting system according to claim 12, wherein each of the signal relay stations comprises:
a receiver configured to receive signals from the main transmitting device and output a correcting time signal; and
a transmitter configured to receive the correcting time signal from the receiver and has packet broadcast events that occur respectively aligned with the other signal relay stations at a plurality of times according to the correcting time signal so as to broadcast the to-be-broadcast data.
